(19) United States
(12) Patent Application Publication
(10) Pub. No.: US 2010/0211491 A1
(43) Pub. Date: Aug. 19, 2010

(54) UNIVERSAL MOBILE ELECTRONIC COMMERCE

(76) Inventors: Gershon M. KAGAN, Beit Shemesh (IL); Jeremy S. Kagan, Beeit Shemesh (IL)

Correspondence Address: STITES & HARBISON PLLC, 1199 NORTH FAIRFAX STREET, SUITE 900, ALEXANDRIA, VA, 22314, US

(21) Appl. No.: 12/767,008

(22) Filed: Apr. 26, 2010

Related U.S. Application Data
(62) Division of application No. 10/575,269, filed on Apr. 11, 2006.

(51) Int. Cl. G06Q 20/00; G06Q 30/00; G06Q 40/00; H04M 3/42

(52) U.S. Cl. 705/34; 705/44; 455/414.1

(57) ABSTRACT

Electronic commerce method allowing a customer having an account with a first payment service provider based in a home network to purchase goods and services from a merchant having an account with a second payment service provider based in a remote network, including:
first payment service provider with which a customer desiring a transaction with a merchant has an account;
a home network on which first payment service provider is based;
second payment service provider with which the merchant has an account;
a remote network on which second payment service provider is based, by means of which the merchant communicates with the second payment service provider;
at least two payment gateways, of which first payment gateway is associated with first payment service provider and second payment gateway is associated with second payment service provider; and
a general network by means of which the payment gateways communicate.

### CROSS REFERENCE TO RELATED APPLICATIONS

This application is a divisional of application Ser. No. 10/575,269, filed Apr. 11, 2006 (which is hereby incorporated by reference).

### FIELD OF THE INVENTION

The present invention relates generally to electronic commerce, and in particular to an electronic commerce system for accommodating mobile or roaming users.

### BACKGROUND OF THE INVENTION

Cellular telephony has to a great extent been adapted to accommodate roaming users. It is possible for users to communicate with cellular phones across national and regional borders, across network operators, across electronic payment technologies, and across various systems with proper and reliable handling of billing and accounting issues.

General electronic commerce has lagged in this regard. While credit cards are fairly universal in their use and acceptance, they are not available to everyone, for example, with younger consumers or those employing prepaid services. In some countries, cellular phones are used to perform transactions, but this has yet to be implemented for roaming users. Prepaid services using contactless devices such as the FeliCa chip are used for purchasing additional services located within the system employing the chips. For example, various vending services in stations of public transportation systems in the Far East accept payment via the prepaid transportation authority electronic tokens, but they cannot be used in other countries or systems.

U.S. Pat. No. 5,815,561 to Nguyen et al. discloses a “Method and System for Providing a Demarcated Communication Service” which does work between networks, but is limited to telecommunications.

U.S. Pat. No. 6,345,239 to Bowman-Amuah discloses a “Remote Demonstration of Business Capabilities in an E-Commerce Environment” which really only emphasizes demonstration and simulation, rather than actual commerce.

U.S. patent application Ser. No. 09/850,644, publication number 20020165789, to Dudek et al. discloses a “Product and Service Presentment and Payment System for Mobile E-Commerce” which allows vehicle-based transactions but does not support roaming across national and regional borders or across various systems.

U.S. patent application Ser. No. 09/973,479, publication number 20020098855, to Hartmaier et al. discloses a “Mobility Extended Telephone Application Programming Interface and Method of Use” which deals strictly with messaging and information exchange over the wireless network.

U.S. patent application Ser. No. 09/894,890, publication number 20020052754, to Joyce et al., included herein by reference, discloses a “Convergent Communications Platform and Method for Mobile and Electronic Commerce in a Heterogeneous Network Environment” which does provide options for roaming e-commerce across networks, but is based on a telecommunications system, essentially a single operator, for support.

U.S. patent application Ser. No. 10/096,912, publication number 20030026404, to Joyce et al., included herein by reference, discloses a “Convergent Communications System and Method With a Rule Set for Authorizing, Debiting, Settling and Recharging a Mobile Commerce Account” which does provide options for e-commerce across “heterogeneous” networks, but does not discuss working across different operators.

### SUMMARY OF THE INVENTION

The present invention seeks to provide convenient and transparent roaming electronic commerce across national and regional borders, across network operators, across electronic payment technologies, and across various systems with proper and reliable handling of billing and accounting issues.

There is thus provided, in accordance with a preferred embodiment of the invention, an electronic commerce system for allowing a customer having an account with a first payment service provider based in a home network to purchase goods and services from a merchant having an account with a second payment service provider based in a remote network, the electronic commerce system including:
a first payment service provider with which a customer desiring to perform a transaction with a merchant has an account;
a home network on which the first payment service provider is based;
a second payment service provider with which the merchant has an account;
a remote network on which the second payment service provider is based and by means of which the merchant communicates with the second payment service provider;
at least two payment gateways, of which a first payment gateway is associated with the first payment service provider and a second payment gateway is associated with the second payment service provider; and
a general network by means of which the payment gateways communicate with one another, which will preferably be a secure general network, for example: the SS7 network, a standardized network communications technology including secure point-to-point communication, an internet connection including security provisions, and a secure private network.

Further in accordance with a preferred embodiment of the invention, each payment gateway includes:
a registrar for authenticating and authorizing the networks and the payment service providers that the payment gateway recognizes as being valid parties to the transaction;
a peer recognizer for verifying the identity of other the payment gateways participating in enabling the transaction, which may be by means of a central payment gateway on the general network operative to notify all participating the payment gateways of the existence and identity of any new the payment gateways;
a local transaction interface for accepting requests, responses, and other messages, relating to a transaction, that originate with parties to the transaction that are based on a network on which the payment gateway is based and for forwarding responses, requests, and other messages, relating to a transaction, to parties to the transaction that are based on the network on which the payment gateway is based;
a router for determining, in their respective networks, the payment service providers and the other the payment gateways that are party to the transaction and for directing messages pertaining to the transaction to the respective parties;
a remote transaction interface for accepting responses, requests, and other messages, relating to a transaction, that originate with parties to the transaction that are based on a network on which the payment gateway is not based and for forwarding requests, responses, and other messages, relating to a transaction, to parties to the transaction that are based on the network on which the payment gateway is not based; and
a customer authenticator for verifying the identity of the customer to the remote payment service provider, which may be by means of at least one of: a signature, a SIM card, an identifying object, a secret code, and a biometric identifier, and which requires verification of the identity of the customer that is completed by the customer at the location of the merchant or that may require confirmation from the first payment service provider wherein the customer has an account.

Additionally, in accordance with a preferred embodiment of the invention each payment gateway further includes:
settler for transferring all credits and debits among all parties to the transaction;
a persistent storage device, which may include a database system, for maintaining a record of the transaction and its status;
a pricing agent for determining the total cost to the customer of the transaction, including charges added thereto by all parties to the transaction;
an advisor for relaying, from the pricing agent via the local transaction interface, the corrected total cost information to the customer via the remote network and for returning, via the local transaction interface, the customer's confirmation to proceed with the transaction; and
a foreign exchange adjuster for correcting the total cost of the transaction for differences in the currency exchange rates for currencies used by the parties to the transaction and for converting, according to suitable currency exchange rates, all costs and charges into the currency employed by the first payment service provider wherein the customer has an account.

Further, in accordance with a preferred embodiment of the invention, the functions of one or more of the settler, the pricing agent, the advisor, and the foreign exchange adjuster are performed by an external settler, an external pricing agent, an external advisor, and an external foreign exchange adjuster respectively, resident on parties to the transaction external to the payment gateway; and the payment gateway further includes a relay interface for relaying, from the external parties, the results of the functions to the at least one of: the settler, the pricing agent, and the advisor, respectively, for further processing.

In a further preferred embodiment of the invention, the customer has a multiplicity of accounts with a multiplicity of respective the first payment service providers and wherein the customer selects a particular account for executing the transaction and wherein the router directs messages pertaining to the transaction to the first payment service provider with which the customer has the selected account. The multiplicity of accounts preferably includes at least one of: a credit card; a debit card; a preauthorized credit line; a prepaid debit account; a rechargeable prepaid debit account, which employs a memory storage device carried by the customer that is preferably readable by a contactless device at the location of the merchant; a prepaid telephony account; and a postpaid telephony account.

A payment gateway for communication with at least one similar payment gateway for enabling a transaction desired by a customer having an account with a first payment service provider based in a home network from a merchant having an account with a second payment service provider based in a remote network, as part of the commerce system as described hereinabove.

There is further provided, in accordance with an additionally preferred embodiment of the invention, for use in an electronic commerce system allowing a customer having an account with a first payment service provider based in a home network to purchase goods and services from a merchant having an account with a second payment service provider based in a remote network, a method for executing a transaction desired by a customer including the steps of:
initiating, by the customer, a desired transaction with a merchant having an account with a second payment service provider based in a remote network;
selecting a payment option, by the customer, wherein there is an association between a first payment service provider and a selected payment option, and wherein the step of selecting a payment option defines a first payment service provider and a home network in which it is based, wherein the customer has an account, and the payment options include: a credit card, a debit card, a preauthorized credit line, a prepaid debit account, a rechargeable prepaid debit account which employs a memory storage device carried by the customer and preferably readable by a contactless device at the location of the merchant, a prepaid telephony account, and a postpaid telephony account;
sending, by the merchant to the second payment service provider, of authorization request for payment for the transaction;
forwarding the authorization request from the second payment service provider to the first payment service provider wherein the customer has an account;
authorizing, by the first payment service provider, payment for the transaction;
forwarding the payment authorization for the transaction from the first payment service provider to the second payment service provider;
authenticating the customer, which may additionally include the step of identifying the customer by suitable means, such as a signature, a SIM card, an identifying object, a secret code, or a biometric identifier, which requires confirmation that is completed by the customer at the location of the merchant or that is from the first payment service provider wherein the customer has an account;
approving the fulfillment of the transaction;
fulfilling the transaction desired by the customer; and
settling financial obligations arising from the transaction among the parties thereto, which may further include the step of recording the details of the transaction in at least one persistent storage device, wherein the persistent storage device is resident on at least one of the first and second payment gateways, and wherein the details of the transaction are accessible to both the first and second payment service providers.

Further in accordance with an additionally preferred embodiment of the invention, the step of forwarding the authorization request includes the steps of:
relaying the authorization request, by the second payment service provider, to a second payment gateway connected to the remote network;
associating, by the second payment gateway, the home network and the first payment service provider wherein the customer has an account, defined in the step of selecting, with a first payment gateway connected to the home network;
redirecting the authorization request, by the second payment gateway to the first payment gateway via a general network, preferably be a secure general network, for example: the SS7 network, a standardized network communications technology including secure point-to-point communication, an internet connection including security provisions, and a secure private network; and
conveying, by the first payment gateway, the authorization request to the first payment service provider wherein the customer has an account.

Additionally in accordance with a preferred embodiment of the invention, the step of authenticating further includes the steps of:
calculating the total cost of the transaction, wherein the total cost includes a price for goods and services desired to be purchased by the customer and a multiplicity of additional charges added to the price by the parties to the transaction, and may further include the step of converting, according to suitable currency exchange rates, all costs and charges into the currency employed by the first payment service provider wherein the customer has an account;
communicating the total cost from the step of calculating to the customer; and
acquiring the customer's agreement to pay the total cost from the step of calculating.

Further in accordance with a preferred embodiment of the invention, in a case wherein there is a need for additional credit for the customer to pay the total cost of the desired transaction, the step of authenticating further includes the step of recharging the rechargeable prepaid debit account of the customer, which may be performed automatically.

In accordance with a preferred embodiment of the invention, wherein the customer is operative to optionally restart the method from the step of choosing a payment option, in accordance with a number of selectable alternative payment options, the method further includes the step of restarting the method from the step of choosing a payment option in response to a null result from any of the steps of: authorizing, authenticating, approving, associating, identifying, acquiring, and recharging. Further, the second payment service provider is operative to reject the transaction in response to the step of selecting terminating in a null result, further including the step of rejecting the transaction, in response to the step of selecting terminating in a null result.

### BRIEF DESCRIPTION OF THE DRAWINGS

The present invention will be more fully understood and appreciated from the following detailed description, taken in conjunction with the drawings, in which:

FIG. 1 is a high-level block diagram of an electronic commerce system, constructed and operative in accordance with a preferred embodiment of the present invention; and

FIG. 2 is a block diagram of a payment gateway, constructed and operative in accordance with a preferred embodiment of the present invention.

### DETAILED DESCRIPTION OF THE INVENTION

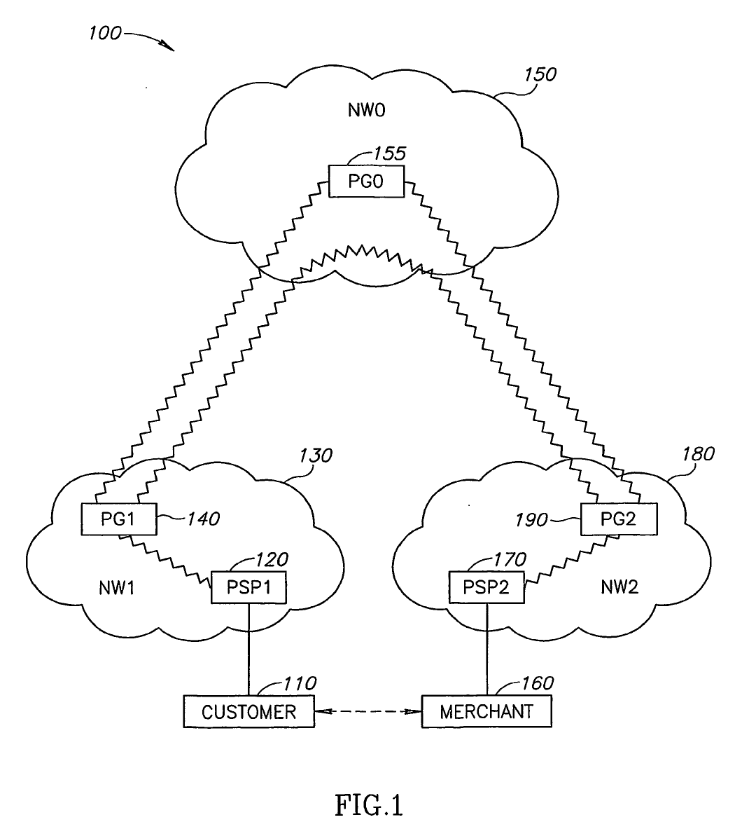

Referring now to FIG. 1, there is shown a high-level block diagram representation of an electronic commerce system, referred to generally as 100, constructed and operative in accordance with a preferred embodiment of the present invention. Electronic commerce system 100 shows the primary parties to a transaction to be executed thereon and the connections between them. Customer 110 has an account with first payment service provider 120, which may be a bank, for example, or other issuer of financial services, which is based on home network 130, NW1. Merchant 160 has an account with second payment service provider 170, which is based on remote network 180, NW2. In response to customer 110 initiating a transaction with merchant 160, merchant 160 will seek authorization for payment for the transaction from its payment service provider, second payment service provider 170, which will seek the authorization from the customer's payment service provider, first payment service provider 120. When both payment service providers 120 and 170 are based on the same network (not pictured), they can usually communicate directly to proceed with the transaction. If, however, customer 110 is in another country or another region, or even if they are not distant, but second payment service provider 170 wherein merchant 160 has an account is based on another, remote network 180, the authorization cannot be obtained directly. It is an aim of the present invention to solve this problem of mobile or roaming electronic commerce.

Second payment service provider 170 of merchant 160 relays the authorization request to second payment gateway 190 which is also based on remote network 180. Second payment gateway 190 is operative to assume the role, vis-a-vis second payment service provider 170, of first payment gateway 140 wherein customer 110 has an account, for the purpose of providing authorizations and other communication required to complete the transaction. In practice, second payment gateway 190 will, by means of its own Peer Recognizer capability, discussed hereinbelow, and possibly with the help of general or master payment gateway 155, locate first payment gateway 140 based on the customer's home network 180 which also serves first payment service provider 120 wherein customer 110 has an account. Second payment gateway 190 will communicate with first payment gateway 140 either directly or with the mediation of general payment gateway 155 via general network 150, which is preferably a standardized network communications technology that offers secure point-to-point communication. One preferred mode of implementing the present invention is to employ the SS7 network used for telecommunications, but it could also be an internet connection including security provision or a private secure network.

It should be noted that the following terminology used hereinbelow is known to those familiar with the art: the term authorization refers to verification of the existence of an account, which may have limitations associated therewith, with a payment service provider; the term authentication refers to verification that the customer is the person he or she purports to be and that the customer's verifying object, such as a cellular telephone or a SIM card is legitimately associated therewith; and the term identification refers to use of a identifying means, such as a signature, PIN, password, or a biometric identifier to confirm the identity of the customer.

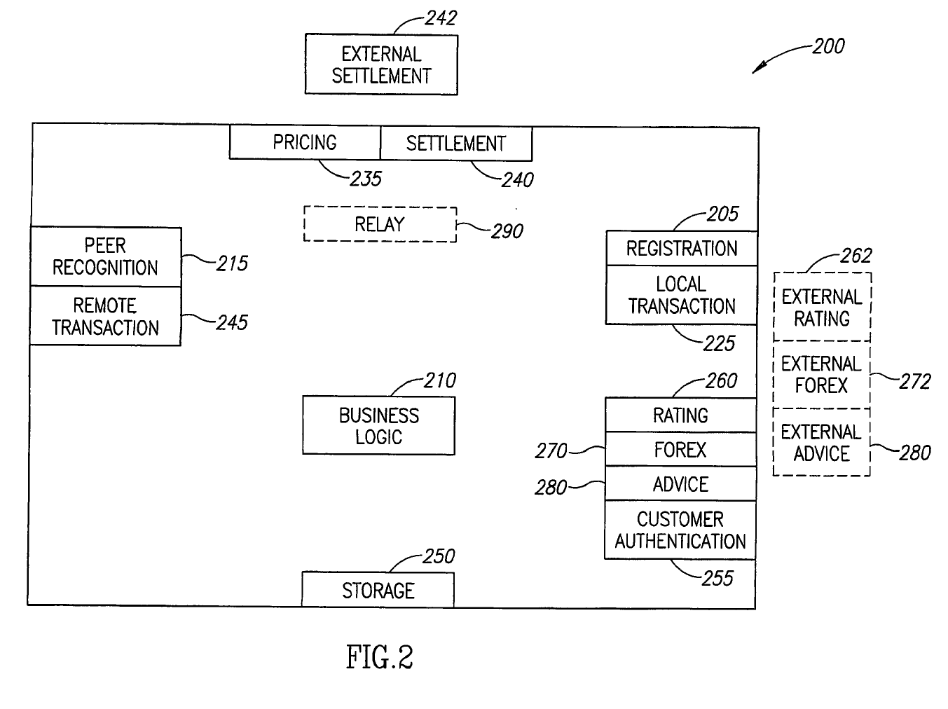

Referring now to FIG. 2, there is shown a block diagram representation of a payment gateway, referred to generally as 200, constructed and operative in accordance with a preferred embodiment of the present invention. Payment gateway 200 is made up of a number of component capabilities or functions, which are grouped according to how they communicate or interface to perform their functions: via the local networks, via the general network, via both of these, or not at all. It should be noted, as mentioned hereinabove, that the payment gateway that is local with respect to the merchant's payment service provider, second payment gateway 190 and second payment service provider 170 respectively in FIG. 1, will fulfill the role of the customer's (first) payment service provider 120 for second payment service provider 170. Similarly, the payment gateway that is local with respect to the customer's payment service provider, first payment gateway 140 and first payment service provider 120 respectively in FIG. 1, will fulfill the role of the merchant's (second) payment service provider 170 for first payment service provider 120. In each case, the “local” network is the one to which the payment gateway is directly connected, and the “remote” network is one to which the payment gateway can only connect via the intermediate general network 150 though it will be “local” for another payment gateway that is party to a transaction.

Payment gateway 200 includes the following components:

Business logic unit 110, the brains of payment gateway 200, controls the functioning of payment gateway 200. It is the repository for all the rules directing how to treat the various messages and requests coming to payment gateway 200 and how to accommodate, in doing so, all external systems and networks with which payment gateway 200 communicates in processing a transaction.

Registrar 205 authenticates and authorizes the networks and payment service providers that are recognized as being valid parties to transactions. This function is typically performed mutually, so that payment gateway 200 will be recognized by the parties to a transaction. This function is crucial in preventing fraud. Included in this is registration in other electronic commerce systems, such as OSA/Parlay Framework.

Peer recognizer 215 verifies the identity of other payment gateways participating in enabling a transaction. This is analogous to the function of registrar 205, but for payment gateways. A new payment gateway will be recognized by payment gateway 200 after receiving confirmation from a general or master payment gateway on the general network. In practice, when a new payment gateway joins the electronic commerce system, all existing payment gateways will be sent a secure message from the master payment gateway to recognize the new payment gateway.

Local transaction interface 225 accepts, from the merchant's payment service provider, a request for authorization for eventual forwarding to the customer's home network and forwards the response originating from the customer's home network, to the merchant's payment service provider. Similarly, when payment gateway 200 is local to the customer's home network, local transaction interface 225 forwards a request for authorization originating from the merchant's payment service provider to the customer's payment service provider and accepts therefrom a response for forwarding to the merchant's payment service provider. Local transaction interface 225 conforms to standard and known protocols, such as OSA/Parlay.

Router 235 determines the payment service providers and the other payment gateways, in their respective networks, that are party to the transaction and directs messages pertaining to the transaction to the respective parties. This includes confirming recognition of the other payment gateways using peer recognizer 215, which will then provide the needed routing address. Router 235 also conforms to standard and known protocols, such as OSA/Parlay, and employs them to carry out its tasks.

Remote transaction interface 245 is analogous to local transaction interface 225 with respect to messages originating from a non-local payment service provider via the general network. It should be noted that the general network is preferably a standardized network communications technology that offers secure point-to-point communication, and that a preferred mode of implementing the present invention is to employ the SS7 network used for telecommunications, but it could also be an internet connection including security provision or a private secure network. Remote transaction interface 245 forwards, via a payment gateway on the customer's home network the request for authorization to the customer's payment service provider and accepts, from the payment gateway on the customer's home network, a response, from the customer's payment service provider, to the authorization request. Similarly, when payment gateway 200 is local to the customer's home network, remote transaction interface 245 accepts a request for authorization originating from the merchant's payment service provider for the customer's payment service provider and forwards to the payment gateway on the merchant's local network the response from the customer's payment service provider. Remote transaction interface 245 also conforms to standard and known protocols, such as OSA/Parlay.

Customer authenticator 255 verifies the identity of the customer to the remote payment service provider. This may be by means of password or PIN authentication, by signature, or by biometric authentication, such as fingerprints, voiceprints, or retinal images. It should be noted that any other identity authentication technology that may become available and feasible for use is included in the present invention. In general, this authentication function will be performed locally to the merchant's point of sale terminal, wherein the customer's biometric data will be stored on a magnetic storage device or a memory chip, for example, carried by the customer in a financial card, a SIM card, a cellular phone handset, or some other portable token. In some cases, confirmation may be required from the customer's payment service provider on the customer's home network, though the delay resulting from this option, makes it less desirable, except perhaps for large, expensive, purchases.

There are additional functions required for the transaction which may be performed by payment gateway 200 or may be performed by other parties in the electronic commerce system. In the latter case, the following components of payment gateway 200 will accept, possibly process, and forward the results of those functions, rather than actually performing them. These additional functions include:

Settler 240 transfers all credits and debits among all parties to the transaction. This function is likely to be performed for many transactions in batch mode some time after they occur, which can save costs to the parties such as funds transfer charges. It could be done monthly, weekly, daily, or eventually, in real time. If this is to be performed by a payment gateway 200, it is likely to be by the general or master payment gateway resident in the general network.

Persistent storage device 250, which may preferably employ a database system, maintains a record of the transaction and its status. This is necessary to allow verification that all obligations have been satisfied, in cases of subsequent inquiry or protests. It is expected that most, if not all, parties to the transaction will maintain some such record-keeping function.

Pricing agent 260 performs rating or determining the total cost to the customer of the transaction, including charges added thereto by all parties to the transaction.

Foreign exchange adjuster 270 corrects, where necessary, the total cost of the transaction for differences in the currency exchange rates for currencies used by the parties to the transaction and converts, according to suitable currency exchange rates, all costs and charges into the currency employed by the first payment service provider wherein the customer has an account. This function requires maintaining updated currency exchange rates, possibly with real time data feeds over a general network.

Advisor 280 relays from pricing agent 260, via local transaction interface 225 and the merchant's payment service provider, the corrected total cost information to the customer and returns the customer's acceptance of the corrected total cost and confirmation to proceed with the transaction.

In some cases, the functions of one or more of settler 240, pricing agent 260, foreign exchange adjuster 270, and advisor 280 may performed by an external settler 242, an external pricing agent 262, an external advisor 282, and an external foreign exchange adjuster 272 respectively, which are resident on parties to the transaction external to payment gateway 200. In such cases, relay interface 209 relays the results of those externally-performed functions to settler 240, pricing agent 260, foreign exchange adjuster 270, and advisor 280 on payment gateway 200, respectively, where relevant, for further processing, as though they had been performed on the components of payment gateway 200.

It is instructive to consider a few exemplary scenarios of transactions as executed employing the system of the present invention. In all cases, the invention includes transparent integration with existing protocols such as PayCircle and EX4. Payment methods likely include telephone accounts, either pre-paid or post-paid, financial card, either debit or credit, and electronic cash, as typically stored in a FeliCa chip, which may be on a card, special token (keychain dongle), or on a cellular telephone device. Typical applications of the payment methods are: phone bill for Internet and cell phone digital downloads, financial card for high-valued retail at point-of-sale, and electronic cash for low-valued physical goods and services.

### Supermarket

At a supermarket, the cashier currently may ask, depending on the sophistication of the checkout terminal, “Cash, Debit, or Credit?” In the future, the cashier will ask: “eCash, Cash, FinancialCardOverPhone, Debit, or Credit?” The cashier must set the point-of-sale terminal appropriately. As is currently know to those familiar with the art, “Charging to the Phone Bill” is not likely to be an option at a supermarket. However, nothing in the present invention, notably the payment gateway, inherently disallows Charging to the Phone Bill in a supermarket, unless there is a legislative mandate to that effect.

If the customer selects eCash and the cashier sets the checkout terminal accordingly to eCash, then the customer may wave a cellular telephone near the checkout terminal. This will execute the transaction within a second, even with the phone off. The supermarket may have a dollar limit on eCash transactions, and the payment service providers may have a limit on how much eCash may be stored in a cellular telephone.

If the customer selects Financial Card ash and the cashier sets the checkout terminal accordingly to Financial Card, and the customer waves the phone, the transaction may take up to 30 seconds, or however long traditional credit card transactions take. This is because the customer's telephone will beam Financial Card account information to the checkout terminal, which contacts the merchant's payment service provider. The merchant's payment service provider charges the Financial Card issuer that was beamed from the phone. Note that if the customer has Debit card details stored in the home operator's database, then the subscriber will have to enter a PIN, as is common now. In general, requiring a PIN for Financial Card or Phone Bill transactions are left to the payment service providers to decide based on their credit risk rules. However, the merchant may also request that a PIN (or other identification, e.g., thumb print or retinal scan) be required, though this is not currently part of the Parlay Charging interface protocol.

### Parking Meters, Vending Machines, and Newspaper Stands

Parking meters, vending machines, and newspaper stands typically only accept cash and eCash. There already are systems operating wherein special rail pass and transit lanes accept eCash by means of a contactless communication device interfacing with a memory storage device carried by the customer. This has already been implemented using known FeliCa chip technology in the transit systems of Japan (East and West), Singapore, and Hong Kong for small purchases from vendors located within the Transit Authority stations, such as newspapers and snacks. The present invention will allow a customer of one Transit Authority to use a rail pass in another Transit Authority, even in another country for entry, as well as for such small purchases. Here, too, a FeliCa chip may be located in a cellular telephone and such transactions may be processed in less than a second. The present invention supports handling of eCash for roamers, even internationally. The payment gateway allows the transaction to look like a strictly local one to the payment service provider, while full settlement takes place afterwards, performed by the payment gateway and/or E4X. The relatively small sums, and hence, small risks involved allow transactions to be authorized locally between the customer's device and the merchant's terminal. Thus, the transactions are processed in under a second.

If there is not enough value stored on the chip to cover the transaction, the customer can recharge his phone with eCash from his Financial Card account directly using the phone. This process may even be allowed to occur automatically. Based on current know trends, eCash recharging is allowed from postpaid, rather than prepaid accounts, since prepaid accounts usually involve a premium handling charge.

For a Singapore subscriber roaming to Japan Rail East, the transaction amount in Yen must first be converted to Singapore Dollars before it can be deducted from the subscriber FeliCa chip. The FeliCa chip communicates with a second Sony chip on the phone, which checks the last Yen to Singapore Dollar exchange rate on the phone. If the phone has no exchange rate, or the exchange rate expired, the phone contacts a server in Singapore for an updated exchange rate, which contains a timestamp how long that exchange rate is valid (thereby saving time for other transactions that day). The merchant bills in Yen, while the chip on the phone debits in Singapore Dollars. At the end of the day, Japan Rail East must settle with the Singapore transit authority, which will also require performing a currency conversion. E4X systems are exactly right for drawing aggregate money daily from one authority, and paying another, each in its own currency, while maintaining details of each transaction This allows the Singapore Transit Authority to track its subscriber accounts.

### Internet

There currently are Internet sites may display premium content, say, adult pictures or sport video clips, viewable either on the handset or the PC for a small micropayment. The customer often does not wish to reveal his payment details to the site, and will want to use an opaque identifier, like a temporary TCP/IP address, which will only get translated into his Financial Card or Phone Bill account by his payment service provider. Payment options may include BillToPhoneFinancialCard and BillToPhoneBill. After the customer selects, by clicking, one of these, if being viewed on a handset, the page redirects to the visited (merchant's) site's payment service provider URL, which is operative to handle the temporary TCP/IP address. For roamers, the request gets forwarded to the payment gateway. It is likely that other Internet sites that ship physical goods, like Amazon, would have BillToPhoneFinancialCard as an option, but not BillToPhoneBill. The payment gateways can handle any of these options, subject to what is allowed by law.

Returning now to FIG. 1, there is described hereinbelow, for use in an electronic commerce system 100 allowing a customer 110 having an account with a first payment service provider 120 based in a home network 130 to purchase goods and services from a merchant 160 having an account with a second payment service provider 170 based in a remote network 180, a method for executing a desired by customer 110, further in accordance with a preferred embodiment of the present invention.

The basic method for executing a transaction includes the following steps:
initiating, by the customer, a desired transaction with a merchant having an account with a second payment service provider based in a remote, with respect to the customer's home network, network;
selecting a payment option, by the customer, wherein there is an association between a first (i.e., customer's) payment service provider and a selected payment option, and wherein said step of selecting a payment option defines a first payment service provider and a home network in which it is based, wherein the customer has an account;
   It should be noted that the selection of a payment option and the definition of a first payment service provider by the customer may be an active choice, as described hereinabove in the supermarket scenario, but it may also be passive and de facto, as when a customer with a FeliCa chip token on his person enters a Transit Authority station or makes a small purchase therein, also as described hereinabove. Payment options include: a credit card, a debit card, a preauthorized credit line, a prepaid debit account, a rechargeable prepaid debit account, a prepaid telephony account, and a postpaid telephony account. The rechargeable prepaid debit account employs a memory storage device carried by the customer, which may preferably be readable by a contactless device at the location of the merchant, as described hereinabove in the example of the Transit Authority in the Parking meters, vending machines, and newspaper stands scenario.
sending, by the merchant to the second payment service provider, of a request for authorization of payment for the transaction;
forwarding the authorization request from the second payment service provider to the first payment service provider wherein the customer has an account;
authorizing, by the first payment service provider, payment for the transaction;
forwarding the payment authorization for the transaction from the first payment service provider to the second payment service provider;
authenticating the customer, which may additionally include the step of identifying the customer by suitable means, such as a signature, a SIM card, an identifying object, a secret code, or a biometric identifier;
   Here, too, this may require active response by the customer, or may be passive and de facto resulting from the customer having a FeliCa or other identifying chip token on his person. The size of the transaction and other risk factors will usually determine how rigorous an authentication and/or identification process the merchant or the merchant's second payment service provider will require, as well as whether it can be performed locally between the customer and the merchant's point of sale terminal or requires some verification from the customer's home payment service provider.
approving the fulfillment of the transaction;
fulfilling the transaction desired by the customer; and
settling financial obligations arising from the transaction among the parties thereto.

The unique contribution of the present invention comes into play when the customer is roaming; that is, seeking to perform a transaction with a merchant located in another network, region, or country. To enable roaming electronic commerce, the method includes, in the step of forwarding the authorization request, the following additional steps:
relaying the authorization request, made by the second payment service provider, to a second payment gateway connected to the remote network wherein they both are based;
associating, by the second payment gateway, the home network of the customer and the first payment service provider wherein the customer has an account, which were defined in the above of selecting, with a first payment gateway connected to the home network of the customer;
redirecting the authorization request, by the second payment gateway to the first payment gateway via a general network, which will preferably be a secure general network, for example: the SS7 network, a standardized network communications technology including secure point-to-point communication, an internet connection including security provisions, and a secure private network ; and
conveying, by the first payment gateway, the authorization request to the first payment service provider wherein the customer has an account.

Again in the case of roaming the step of forwarding the payment authorization is forwarding the payment authorization via the home network to the first payment gateway and from the first payment gateway to the second payment gateway via the general network and from the second payment gateway via the remote network to the second payment service provider.

In order to complete the transactions, the method further includes, in the step of authenticating, the following steps:
calculating the total cost of the transaction, wherein the total cost includes a price for goods and services desired to be purchased by the customer and any additional charges, such as service and handling charges, added to the price by the parties to the transaction, which may also, where required, include converting, according to suitable currency exchange rates, all costs and charges into the currency employed by the first payment service provider wherein the customer has an account;
communicating the total cost from the step of calculating to the customer; and
acquiring the customer's agreement to pay the total cost from the step of calculating.

In a case where the customer needs additional credit to pay the total cost of the desired transaction, the step of authenticating further includes the step of recharging the rechargeable prepaid debit account of the customer, which may be performed automatically.

To complete the transaction, the step of fulfilling includes the step of recording the details of the transaction in at least one persistent storage device, which may include a database, which is resident on one or both the first and second payment gateways, wherein details of the transaction are accessible to both the first and second payment service providers.

If any of the steps of authorizing, authenticating, approving, associating, identifying, acquiring, and recharging fails and yields a null result, the customer may be given another chance to carry out the transaction by selecting a different payment option and restarting the method from that step of selecting a payment. If the customer does not or is not able to restart the process or if all in all alternative payment options fail, yielding a null result, the transaction is rejected by the merchant's second payment service provider.

It will further be appreciated by persons skilled in the art that the scope of the present invention is not limited by what has been specifically shown and described hereinabove, merely by way of example. Rather, the scope of the present invention is defined solely by the claims, which follow.

1. A method of performing a monetary transaction between first and second entities, comprising:
receiving by a second payment gateway belonging to a second cellular network operator, a request of a second entity to transfer money from an account of a first entity not registered with the second cellular network to an account of the second entity;
transferring the request of the second entity from the second payment gateway to a first payment gateway in a first cellular network managing the account of the first entity, over an inter cellular operator network;
receiving by the second payment gateway, from the first payment gateway, an acknowledgement of the money transfer in real time; and
notifying the second entity that money transfer was authorized responsive to receiving the acknowledgement.

2. The method of claim 1, wherein transferring the request of the second entity from the second payment gateway to the first payment gateway comprises transferring through a master payment gateway, which links payment gateways of a plurality of cellular networks.

3. The method of claim 1, further comprising authenticating the second entity from which the request to transfer money was received, before notifying that the money transfer was authorized.

4. The method of claim 1, wherein transferring the request comprises transferring with the request an indication of a method to bill the first account, the method being selected from a group including billing a financial card and immediate cash billing.

5. The method of claim 1, wherein receiving the request of a second entity comprises receiving a request with an indication of the cellular network of the first account.
